SEQUENCE LISTING (1 sequence)

SEQ ID NO: 1 - DNA, 21 bp, Artificial Sequence
  Description of Artificial Sequence Synthetic oligonucleotide
ttgtggtggtggtggtggtgg

(19) United States
(12) Patent Application Publication
(10) Pub. No.: US 2008/0132429 A1
(43) Pub. Date: Jun. 5, 2008

(54) BIOLOGICAL MICROARRAYS WITH ENHANCED SIGNAL YIELD

(75) Inventors: Alexander N. Perov, Woodridge, IL (US); Julia B. Golova, Burr Ridge, IL (US); Boris Chernov, Burr Ridge, IL (US); Darrell P. Chandler, Yorkville, IL (US)

Correspondence Address: BARNES & THORNBURG LLP, P.O. BOX 2786, CHICAGO, IL, 60690-2786, US

(73) Assignee: UChicago Argonne, Chicago, IL (US)

(21) Appl. No.: 11/738,329

(22) Filed: Apr. 20, 2007

Related U.S. Application Data
(60) Provisional application No. 60/802,899, filed on May 23, 2006.

(51) Int. Cl. C40B 50/18; C40B 50/14

(52) U.S. Cl. 506/32; 506/30

(57) ABSTRACT

Methods and compositions provide biological microarrays with enhanced fluorescent and luminescent signals by providing refraction index variations within a porous composition used to prepare the microarrays.

### CROSS-REFERENCE

This application claims priority to U.S. provisional application Ser. No. 60/802,899 filed May 23, 2006.

Methods and compositions provide biological microarrays with enhanced fluorescent and luminescent signals by providing refraction index variations within a porous composition used to prepare the microarrays.

The United States Government has rights in this invention pursuant to Contract No. W-31-109-ENG-38 between the United States Government and The University of Chicago and/or pursuant to Contract No. DE-AC02-06CH11357 between the United States Government and UChicago Argonne, LLC representing Argonne National Laboratory.

### BACKGROUND

Biochips have been proved to be a very useful tool in such diverse fields as gene discovery, characterization and functional gene analysis, identification of drug-resistant strains of microorganisms, screening for mutations and gene re-arrangements associated with oncological diseases. In an example of an assay using biochips, fluorescently labeled target molecules interact or hybridize with the biomolecular probes, such as oligonucleotides, that are immobilized at predetermined locations on the microarray substrate. The strength of target binding to a particular probe (target-specific hybridization) depends on the degree of complementarity between the molecules in question. As a result, after rinsing the biochip with a washing buffer, the target-specific hybridization pattern translates into a characteristic distribution of the fluorescent marker between the array elements, which can be read out using a dedicated fluorescence scanning device (e.g., a biochip reader).

Biochips have been printed on various media e.g., either organic, micro-porous membranes such as nylon or nitrocellulose, or non-porous glass slides chemically treated for probe immobilization. The use of the former, however, is limited to low-density arrays because of the lateral spread of the printing solutions in the relatively the relatively thick membrane due to capillary effects that may lead to probe cross-contamination. For this reason, biochips are predominantly planar arrays in which the biomolecular probes are localized in a monomolecular layer on top of a non-porous solid substrate.

Since the thickness of array elements in the planar arrays is extremely small, only an infinitesimal fraction of the excitation photons has a chance of interacting with the fluorescent marker attached to the target molecules hybridized to the microarray probes. Although, it may seem possible to improve the sensitivity of planar biochips by increasing the surface probe density, in reality, too high probe density may strongly hamper the accessibility of probe molecules and distort the molecular interactions. In particular, from 20-mer oligonucleotides immobilized with a density of ˜10¹³ molecules/cm² only about 10% are accessible for hybridization with target oligonucleotides. Thus, intensities of fluorescence emission in the case of the planar biochips are generally very low, which explains why biochip technology relies so heavily on expensive and rather complex laser scanners for reading biochips. By taking advantage of the confocal design and excitation power densities measured by tens of kilowatts of laser light per square centimeter, these instruments are capable of providing the detection sensitivity required.

The requirement for high sensitivity can be relaxed considerably by increasing the immobilization capacity of biochip substrates. The larger the number of biomolecular probes immobilized per unit area of the substrate, the more intense the fluorescence emission is. This approach is implemented in biochips with a three-dimensional immobilization layer (3D biochips). For example, Khrapko, et al. (U.S. Pat. No. 5,552,270) describe biochips in which probe molecules are bound to a polymeric matrix that consists of separate gel portions or “cells” attached to a solid support. A similar solution is proposed by Beuhler and McGowen (U.S. Pat. No. 6,391,937), who describe a method of making polyacrylamide hydrogels and hydrogel arrays covalently bound to a solid support and deemed advantageous for applications in biochip technology. Hydrogel arrays consisting of plurality of separate gel pads are prepared by mask-guided photopolymerization or, alternatively, by using a laser beam for selective crosslinking the polyacrylamide reactive prepolymer in the array pattern, which greatly facilitates mass production.

Yet another method of making hydrogel-based 3D biochips is described by Hahn and Fagnani (U.S. Pat. No. 6,174,683). In order to avoid difficulties associated with dispensing biomolecular probes onto gel pads of the pre-formed hydrogel array, these authors proposed binding the probes to a hydrogel prepolymer either prior to, or simultaneously with, polymerization of the prepolymer.

Generally, hydrogels are preferred matrices for use in 3D biochips because in the hydrated form they are flexible and therefore provide a solution-like environment for the biomolecular probes interacting with the target molecules. There are, however, examples of 3D biochips known in the art that make use of inorganic immobilization layers. For instance, Tanner et al. (U.S. Pat. No. 6,750,023) describe a biochip that has a porous inorganic immobilization layer adhered to a flat, rigid, non-porous, inorganic understructure. To be used for fabrication of the immobilization layer, the inorganic material is non-absorbing and transparent to light. The examples of such materials are glass or metal oxides. The authors describe a method of biochip fabrication that includes applying a frit layer of individual particles of the inorganic material to a top surface of the solid understructure, the particles having a predetermined mean size, and then firing the frit layer at a temperature exceeding 650° C. in order to form network of inorganic material from the individual particles to create a plurality of interconnected voids of a predetermined mean size dispersed throughout the porous inorganic layer, and having void channels that extend through to a top surface of the porous inorganic layer.

Immobilization capacity of the substrates with a porous layer is proportional to the layer thickness and potentially could be several orders of magnitude higher than that of a planar substrate. In practice, however, one has to account for the trade-off between the immobilization capacity of the array elements on the one hand, and their mechanical stability and kinetic characteristics of the assay on the other. It has been reported both theoretically and experimentally that diffusion of target molecules through a porous layer with binding centers (biomolecular probes) dispersed therein is a much slower process than that in solution, and that the characteristic diffusion time gets longer with both the layer thickness and the concentration of the probes. Taking into account both the above mentioned concerns that limit the porous layer immobilization capacity and the extinction coefficients of the common fluorescent labels used by those skilled in the art, signal intensities one can realistically expect from the 3D biochips still fall short of the desired level.

According to Tanner et al., this issue can be resolved in the case of 3D biochips with an inorganic immobilization layer if the layer is prepared by sintering dispersed powders of materials characterized by a refractive index substantially different from that of the material (e.g. air or aqueous solution of the target DNA) filling the voids in the layer. Provided that the mean size of the voids exceeds 0.1 μm, the high contrast in refractive indices greatly enhances scattering of the excitation light in the immobilization layer, which is equivalent to increasing the average path the excitation photons travel within the layer. The longer the optical path, the higher is probability of exciting the fluorescently labeled target bound there. On the other hand, increased light scattering cannot prevent the fluorescence from escaping the porous layer because the inorganic material of the layer is supposed to be non-absorbing. The list of suitable inorganic materials, as suggested in the Tanner patent, includes various formulations of glass and, more preferably, metal oxides such as TiO₂ (n=2.62 to 2.90) or ZrO₂ (n=2.14).

Unfortunately, the process of fabricating a porous ceramic layer on top of a dense solid substrate described in the Tanner patent is complex and time consuming. In addition, the inventors illustrate it only by a relatively easy case of borosilicate glass that offers little in terms of scattering enhancement especially if the contents of the voids is an aqueous solution or, for example, polyacrylamide gel (for borosilicate glass n=1.47, which is close enough to n=1.33 of water and n=1.55 of polyacrylamide).

The choice of borosilicate glass as a material for the frit layer is dictated by the fact that the process of sintering, which is an essential part of the method proposed by Tanner et al., requires heating the understructure with the frit layer of inorganic particles on top of it to high temperatures (typically in excess of 700° C.). To withstand such heating without warping, the understructure should be made of material with a melting temperature even higher than that of the sintering step. In particular, when the frit layer consists of borosilicate glass (softening point close to 820° C.) the material of the understructure according to Tanner et al. should be a special grade of a calcium aluminosilicate glass (e.g., Corning 1737) characterized by a high melting temperature.

The problem of choosing the right material for the understructure becomes much more complicated if the frit layer a material such as TiO₂. The latter has a melting temperature close 1830° C., which rules out the use of glass—the proper material for the understructure should have a melting temperature in excess of 2000° C.! This limits one's choice to ZrO₂ and, maybe, a few other high-temperature ceramics. A biochip fabricated using such materials would be unacceptably expensive for a disposable device not to mention the cumbersome manufacturing process. Thus, in the context of the Tanner patent, the option of TiO₂ as a material of choice for porous immobilization layer presents a purely theoretical interest because the inventors offer no practically feasible fabrication method compatible with this choice. This conclusion also holds true for ZrO₂.

The sintering step brings about yet another disadvantage. Those of skill in the art understand that the method described in the Tanner patent is not applicable for making patterned porous layers analogous to the gel-pad arrays described by Khrapko et al. or Hahn and Fagnani. In the case of a contiguous porous layer, the minimum pitch of a microarray is limited by lateral spread of the printing solution caused by a capillary effect. According to Tanner et al., for printing with a 200-μm pin the average spot diameter in their experiments was approximately 400 μm—twice the pin size! This means that in terms of maximum attainable array density, biochips described in the Tanner patent fall short of the biochips based on patterned polyacrylamide gels. For example, in the case of microarrays prepared by photopolymerization of acrylamide-based compositions printed with a 150-μm solid pin on a glass slide activated with methacrylic groups (VACR-25C Acrylic Slides, CEL Associates, Pearland, Tex.) a typical size of a gel pad is 100 μm, that is 0.7 times pin diameter.

A composition for immobilizing at least one type of biological molecule, e.g. nucleic acid probes which hybridize to molecules with complementary sequences, includes:
(a) a solid support; and
(b) an immobilization layer on the solid support, wherein the immobilization layer includes an organic matrix and light-scattering centers dispersed therein, and wherein the organic matrix has a different refractive index from the light-scattering centers.

Light-scattering centers include inorganic particles formed from metal oxides, inorganic particles formed from titanium oxides, zirconium oxides, variations, and combinations thereof. Inorganic particles may have a particle size in the range from about 200 to about 1000 nm or from about 250 to about 600 nm.

Light-scattering centers may have complex internal structures, e.g., cores made of titanium dioxide and one or two concentric shells that are made of SiO2 and Al1O3.

Light-scattering centers include a solid core and one or more solid shells, the shells consisting of a material different from that of the core.

Light-scattering centers include bubbles with a gasseous core.

A method for preparing a substrate for immobilizing at least one type of biological molecule includes:
(a) preparing a mixture of at least one gel-forming component and light-scattering centers having a refractive index greater than 1.6;
(b) preparing a coating of the mixture on a solid support; and
(c) curing the coating.

A method of enhancing fluorescent yield in biochips with porous polymeric immobilization layer, includes:
(a) providing a solid support having a top surface with reactive molecules on the surface;
(b) applying a porous polymeric layer on the top surface of the solid support where the polymeric layer includes:
   (i) one or more immobilized biomolecular probes;
   (ii) multiple inclusions of another one or more phases dispersed therein,
wherein the inclusions are characterized by a predetermined mean size, a refractive index substantially different from the refractive index of the porous layer, and low absorption of light.

Suitable materials for polymeric support include cyclic olefin copolymers, polycarbonate, polymethylmethacrylate and polyethylene terephthalate.

A method of enhancing fluorescent yield in biochips with a porous polymeric immobilization layer includes:

(a) providing a solid support having a top surface with reactive molecules thereon; and

(b) applying a porous polymeric layer on the top surface of the solid support, the polymeric layer comprising:
(i) one or more biomolecular probes immobilized therein;
   (ii) multiple inclusions dispersed therein, wherein the inclusions are characterized by a predetermined mean size, a refractive index substantially different from the refractive index of the porous layer, and low absorption of light. The inclusions may have a predetermined mean size in the range of about 0.1 μm to about 0.8 μm, about 0.2 μm to about 0.6 μm, or about 0.3 μm to about 0.55 μm. The difference in refractive indexes between the inclusions of the polymeric layer is at least 0.2, 0.6 or at least 1. The inclusions are predominantly in a solid phase, e.g. an amorphous or single crystal material such as glass, a metal oxide, a silicate, aluminosilicate, boroaluminosilicate or borosilicate glass, TiO₂, Al₂O₃, SiO₂, Cr₂O₃, CuO, ZnO, ZrO₂, and combinations thereof.

A method of preparing a biochip with a hydrogel immobilization layer and enhanced fluorescent yield, includes:

(a) providing a solid support treated to bind to hydrogel molecules;

(b) providing a hydrogel polymerization composition with solid particles dispersed therein, the solid particles characterized as having:
(i) a refractive index of at least 1.8;
(ii) a predetermined mean size; and
(iii) low absorption of light;

(c) placing said hydrogel polymerization composition on the solid support;

(d) photochemically crosslinking the hydrogel polymerization composition to obtain the hydrogel with the solid particles entrapped therein;

(e) dispensing solutions of biomolecular probes on the hydrogel, and

(f) covalently binding the biomolecular probes to reactive groups of the hydrogel.

A method of preparing a hydrogel-based biochip with enhanced fluorescent yield and a hydrogel immobilization layer patterned as an array of spatially separated hydrogel cells, includes:

(a) providing a solid support having a top surface with reactive molecules;

(b) providing a hydrogel polymerization composition;

(c) providing one or more solutions of biomolecular probes chemically the modified to allow covalent binding to gel-forming components of said hydrogel polymerization composition, the solutions miscible with the polymerization composition of step (b);

(d) providing a dispersion of solid particles, the dispersion miscible with the polymerization composition of step (b), and the solid particles characterized as having:
(i) a refractive index of at least 1.8;
(ii) a predetermined mean size;
(iii) low absorption of light; and

(e) combining together the solutions of biomolecular probes of step (c) with polymerization composition and dispersion of steps (b) and (d), and stirring the resulting polymerization compositions;

(f) dispensing the compositions of step (e) as droplets at predetermined locations on the support of step (a);

(g) photochemically polymerizing the droplets of step (f) to obtain cells of the hydrogel array with the solid particles entrapped therein.

Methods and compositions described herein improve efficiency of fluorescence excitation in hydrogel-based biochips. Better usage of the excitation light and higher signal intensity facilitates designing simpler and less expensive microarray readers, which is essential, for instance, for field-portable instruments for biological warfare monitoring and point-of-service applications in medical diagnostics. The method is equally applicable to biochips using a contiguous immobilization layer and those employing patterned hydrogels such as gel-pad arrays fabricated by spatially selective photopolymerization. Hydrogel-based biochips fabricated using copolymerization technology are most beneficial for mass-scale commercial production.

### DEFINITIONS

Sinter—to heat a powdered substance without thoroughly melting it, causing it to fuse into a solid but porous mass.

### BRIEF DESCRIPTION OF THE DRAWINGS

FIG. 1 illustrates the concept of increasing the optical path of light 101 traveling through an intrinsically transparent medium 103 by introducing in the medium multiple inclusions 102 of a different phase (i.e. inorganic particles) characterized by a refractive index substantially different from that of the medium. The scattered light rays 104 are more likely to interact with fluorescent molecules that could be present in the medium.

FIG. 2A depicts an immobilization-site cross-section of a biochip printed on a substrate with continuous porous immobilization layer 202 having light-scattering particles 204 dispersed therein. The immobilization layer 202 is attached to a solid support 203. The immobilization site 205 is a zone in the layer 202 where a solution of a biomolecular probe was dispensed for immobilization. Upon impinging the immobilization layer, the excitation light 201 gets scattered by the particles 204.

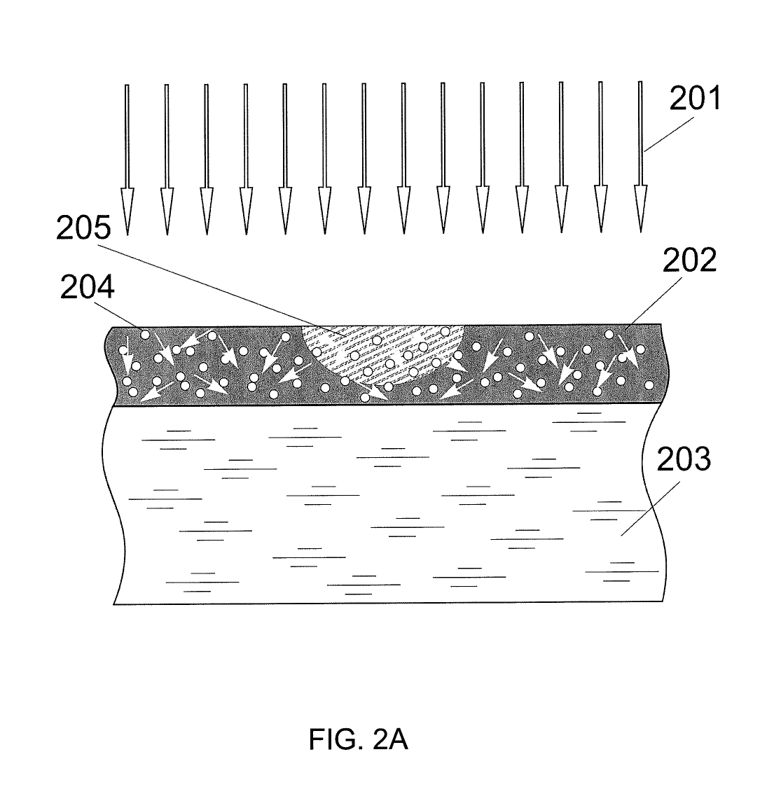

FIG. 2B shows a biochip comprising an array of spots 208 printed on a porous polymeric immobilization layer 206 attached to a solid support 207.

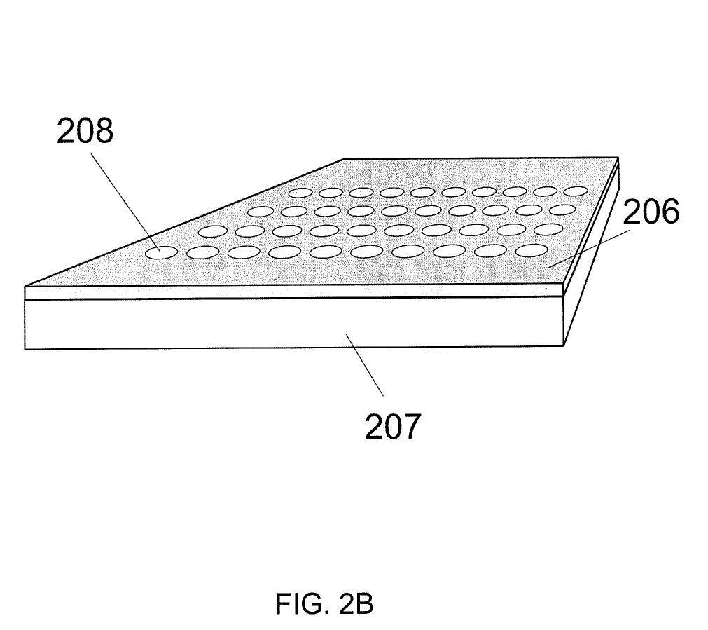

FIG. 3A depicts a gel pad 302 attached to a solid support 303 and having inclusions 305 of a different phase (i.e. inorganic particles) dispersed therein. The presence of inclusions with a refractive index different from that of the gel intensifies scattering of the excitation light 301 (304 indicates scattered light rays inside the gel pad).

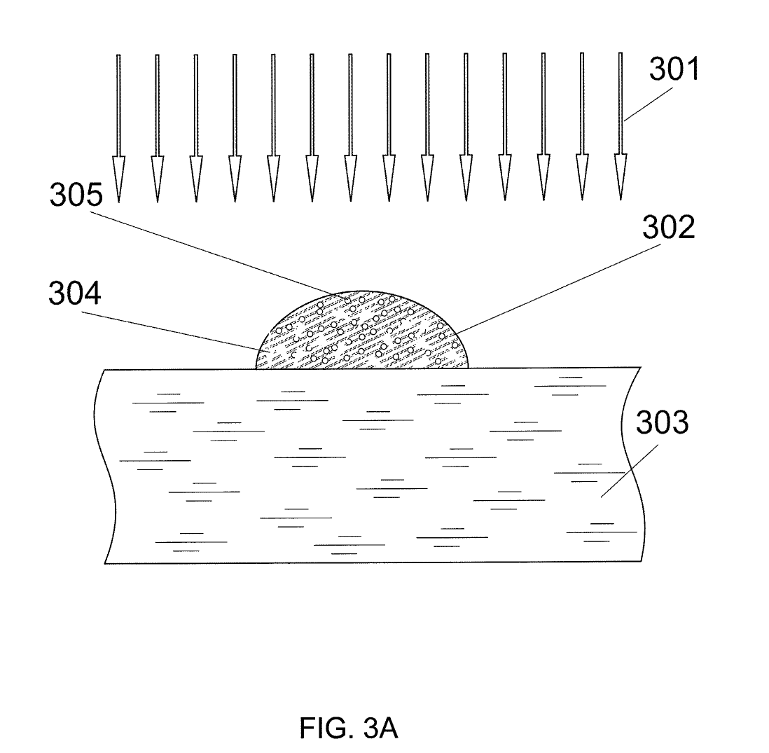

FIG. 3B shows a biochip comprising an array of gel pads 307 fabricated on a solid support 306 by dispensing droplets of a polymerization composition and curing them with UV light.

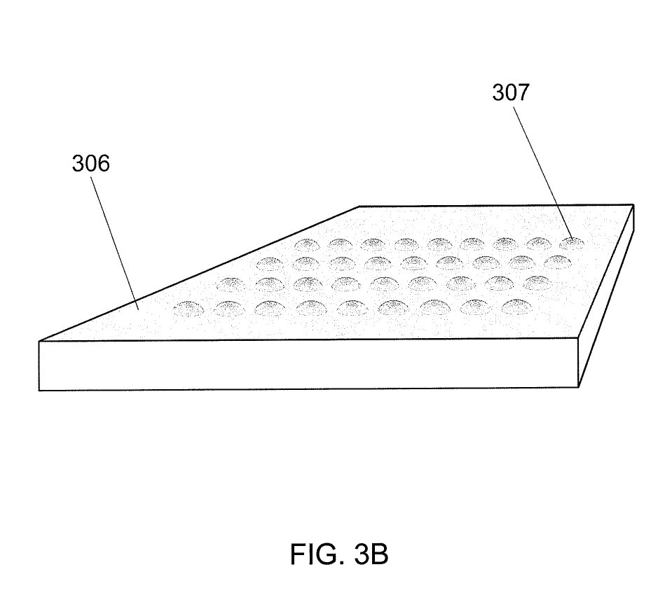

FIG. 4 is a diagrammatic representation comparing optical signals at the wavelength of Cy3 fluorescence measured for a glass slide with no gel attached to it (“slide”) and lens-like pads of polyacrylamide gel fabricated on top of a glass slide and composed of: an unmodified gel (“gel”); a gel modified by adding 110% w/w of a DuPont Titanium Technologies Ti-Pure R931 grade of titanium dioxide (“gel+TiO₂”); a gel modified by immobilizing a Cy3-labeled oligonucleotide (“gel+oligo”); and a gel modified by immobilizing a Cy3-labeled oligonucleotide and adding 10% w/w of a DuPont grade 531 of titanium dioxide (“gel+oligo+TiO₂”). All the signals are normalized to that corresponding to “gel+oligo”.

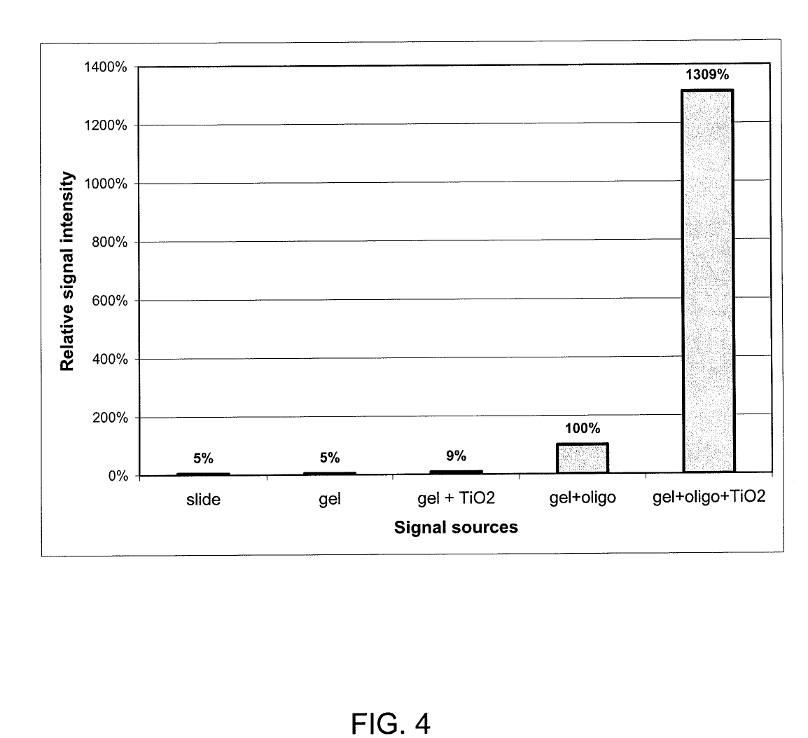

### DETAILED DESCRIPTION

A method of enhancing signal yield of biochips with biomolecular probes immobilized in hydrogel that may form a contiguous layer, or be patterned as an array of spatially separated gel pads is described. Biological microarrays (biochips) with 3-dimensional binding sites include a polymeric matrix with biomolecular probes immobilized therein. The matrix is bound to a solid substrate. Preparing hydrogel-based biochips with enhanced signal yield includes modification of the polymerization composition used for gel preparation by adding to it a certain amount of dispersed light scattering material. The material is characterized by: (1) mean particle sizes in the range of 200 to 1000 nm, or in the range of 300 to 550 nm; (2) a refractive index exceeding 1.6, preferably exceeding 2.4; and (3) negligible absorption of light. Examples of such materials are glass, TiO2, ZrO2, Al2O3, Cr2O3, CuO, ZnO, SiO2 and combinations thereof. Upon gel polymerization, the particles of the material, whose size is larger than the typical pore size in the gel, become permanently entrapped in the gel. The intensified light scattering is advantageous in that it increases average optical path of the excitation light within the gel and in that way improves the efficiency of fluorescence excitation. The presence of the light scattering particles does not affect the fluorescence emission because the material of the particles exhibits negligible absorption at the emission wavelength.

Hydrogel-based biochips are prepared by a method of copolymerization which includes the steps: (1) providing a solid substrate with a top surface chemically modified to allow covalent binding of hydrogel, (2) providing one or more polymerization compositions, said compositions comprising: (a) a gel monomer; (b) a crosslinking agent; (c) a biomolecular probe chemically modified for covalent binding to the gel; and (d) light scattering particles; (3) dispensing polymerization compositions onto the solid substrate; and (4) exposing the array of droplets of the polymerization compositions to UV light to initiate polymerization. The aforementioned light scattering particles are characterized, e.g., as by a mean size in the range of 300 to 550 nm, and a structure that includes a core of titanium dioxide in the form of rutile and one or more shells. Suitable materials for the shells include Al2O3, SiO2, and an organic polymer. Powders consisting of particles structured as described are known to those skilled in the art as being chemically inert and less prone to flocculation in suspensions. Powders meeting the above criteria can be found among various commercial grades of titanium dioxide-based pigments manufactured by vendors such as DuPont.

To modify the gel properties, the rutile powder is added to the polymerization composition intended for gel preparation, and the mixture is carefully stirred in order to obtain a stable suspension. The suspension is then used for fabricating biochips according to a standard protocol. Although the presence of rutile slightly decreases the gel volume available for probe immobilization, a proof-of-concept experiment showed that the gain in fluorescence signal due to more efficient use of the excitation light by far outweighs the loss of signal caused by the change in immobilization capacity. Microarrays with a 3D immobilization layer featuring increased light scattering are fabricated by taking advantage of the technology of gel-element microarrays.

The effect of enhanced light scattering can be achieved even when the material of the porous layer is glass. There is a condition for this: the voids between the particles of the porous layer should be filled with air or a similar gas such as nitrogen. This ensures that the difference in refractive indices between the particles and the matter in the voids is high enough (about 0.5) to cause considerable light scattering, which is achieved simply as a byproduct of porous layer being made of glass. So a step of “configuring inorganic material and contents of voids to exhibit a high contrast in their indices of refraction relative to each other such as to scatter light” is attainable.

Taking advantage of light scattering properties of the porous glass layer and dispensing on it a hydrogel prepolymer solution, results in light scattering in the immobilization layer upon gel polymerization that does not differ much from light scattering in a gel without any inorganic particles present. This is because the refractive index of almost any organic polymer, polyacrylamide hydrogel included, is quite close to that of majority of glass formulations (1.45 to 1.55).

Upon UV light absorption, rutile TiO₂ becomes a photocatalyst. A glass-like SiOₓ suppresses photocatalytic activity. Al₂O₃ coating enhances dispersibility and flocculation resistance. TiO₂ grades can be made hydrophobic, hydrophilic, or neither, depending upon the organic surface treatment applied to the particles.

In summary, the materials and methods described herein do not require the support of an immobilization layer, do not require the light scattering particles to form a network to ensure mechanical stability of the porous layer, and provide enough surface for immobilization of biomolecular probes. Methods and compositions do not rely on sintering as one of the steps in the technological chain and, therefore, can make use of various high-index materials regardless of their melting temperature; and is applicable to both biochips with a contiguous immobilization layer and biochips fabricated using the copolymerization technology.

Materials and methods disclosed are broadly applicable to all areas where microarray technology is currently being employed. Low-cost microarrays and low-cost reading instruments are developed and deployed at the point of use, in either medical or environmental applications. The materials and methods are useful for nucleic acid, protein, immunological, small molecule and other types of diagnostics, and are not limited by the biological composition of the sample or array. Other applications include clinical diagnostics based on DNA or immunological analysis, e.g. assays for recognition of antibiotic-resistant tuberculosis or other infectious diseases, or diagnosing BSE, bovine tuberculosis or avian influenza in food animals. In comparison to existing solutions, the present disclosure offers a considerable reduction in the overall cost of a microarray test. Advantages include compatibility with technology of copolymerization microarrays; and compatibility with both glass and plastic substrates.

### EXAMPLE 1

### Preparation of Biochips with Enhanced Signal Yield

Biochips with enhanced signal yield are prepared by a copolymerization technique. The following example describes methods for preparation of biochips with use of polyacrylamide reactive prepolymer.

Glass slides. For preparation of biochips commercially available acrylic glass slides (VACR-25C, Cel Associates, Inc., Pearland, Tex.) are used. As an alternative, regular untreated microscope glass slides, such as FISHER finest premium microscope slides (Fisher Scientific, Pittsburgh, Pa.), could be used after treating them with Bind Silane (Amersham Biosciences), washing with ethanol and deionized water, and subsequent drying as described by Rubina et al. (2004).

Polymerization compositions. 0.5 gram of 40% acrylamide/methylenebisacrylamide (Bis) solution (19:1) obtained from Bio-Rad, Hercules, Calif., 2.6 gram of glycerol (Aldrich, Milwaukee, Wis.,), 0.5 gram of 0.2 M sodium-phosphate buffer (pH 7.2), and 0.4 gram of TiO₂ powder (DuPont Grade 931) were combined together in a 15 ml plastic test tube and stirred for 20 minutes at 20,000 rpm with a 50% duty cycle (3 min stirring followed by 3 min pause for stirrer cooling). As a stirrer is suitable an OMNI TH115-K homogenizer equipped with a stainless-steel generator tip. On completion of stirring, the composition was dispensed into the wells of a 384-well microplate (Genetix, New Milton, UK), typically 20 μl per well, and stored at −20° C. in a freezer.

According to the manufacturer's specifications, the Grade 931 TiO₂ powder is characterized by 550 nm mean particle sizes. The particles have a rutile core isolated by a SiO₂ shell and an outer Al₂O₃ shell that helps to stabilize suspensions by reducing the tendency to flocculation.

To evaluate the effect of fluorescence enhancement, compositions that contained a Cy3 labeled 20-mer oligonucleotide (5′Cy3-TTGTGGTGGTGGTGGTGGTGG-Met-3′) in a 100 nM concentration were used. “Met” in the oligonucleotide sequence stands for a methacrylic group at the 3′ end added in the process of synthesis to allow oligonucleotide binding to the hydrogel matrix.

Spotting and gel polymerization. Polymerization compositions were spotted on the slides using a QArray2 robotic arrayer (Genetix, New Milton, UK). The pins used in the arrayer print head were standard solid titanium pins (Genetix) with either 300 or 150 μm tip diameter. For the Cel Associates slides used, these pins deposited droplets with a diameter of 100 and 200 μm, respectively.

The arrays of droplets were polymerized for 30 minutes using a UV lamp that comprised two FB-TI-110A tubes (Fisher Scientific) emitting 15 W each with a peak emission intensity at 312 nm. The distance between the tubes and the slides were about 10 cm.

Fluorescence measurements. The biochips were scanned using a ScanArray 3000 microarray scanner (Packard BioScience). The images were processed to extract integral signal intensities corrected for the slide background. To evaluate the effects of increased light scattering induced by titanium dioxide particles, the microarrays also comprised reference gel elements that: (a) contained TiO₂ but not the labeled oligo, (b) contained the labeled oligo but were free from TiO₂, and (c) contained neither TiO₂ nor the oligo.

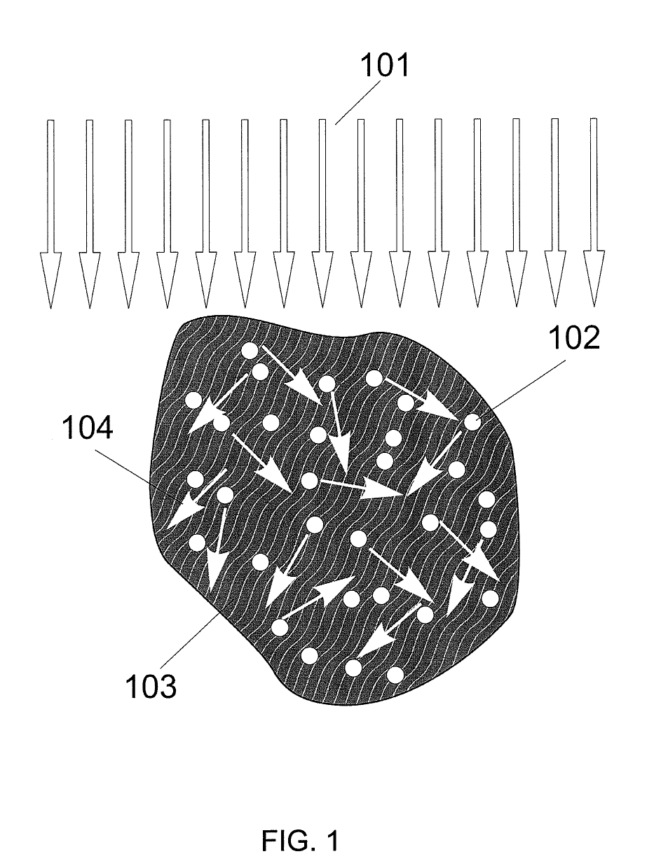

FIG. 1 illustrates effect of incorporating DuPont grade R-931 rutile into elements of gel-based array prepared by the co-polymerization technique. The concentration of rutile in the polymerization composition was 10% (w/w). The increased scattering affects both the background signal (caused by reflection of excitation light from the gel) and the fluorescence signal associated with the fluorophore bound in some of the gel elements. However, while the gel background increases by approximately 80%, the increase in useful signal exceeds 1300%.

### PUBLICATIONS CITED

The following are incorporated by reference to the extent they relate Materials or Methods of the present disclosure.
Beuhler, and McGowen, U.S. Pat. No. 6,391,937.
Fodor, et al., U.S. Pat. No. 5,744,305.
Glazer et al., U.S. Pat. No. 6,824,866.
Hahn, S, and Fagnani, U.S. Pat. No. 6,174,683.
Khrapko et al., U.S. Pat. No. 5,552,270.
Livshits, M. A., and Mirzabekov, A. D., (1996) Biophys. Journal, 71, 2795-2801.
Peterson et al. (2001) Nucl. Acids Res., 29, 5163-5168.
Rubina et al., (2004), Analytical Biochemistry, 325 (92-106).
Sorokin et al., (2003) Journal of biomolecular Structure & Dynamics, Vol. 21, No 2, pp. 279-288.
Tanner et al., U.S. Pat. No. 6,750,023.

We claim:

1. A composition for immobilizing at least one biological molecule, the composition comprising:
(a) a solid support; and
(b) an immobilization layer on the solid support, wherein the immobilization layer includes an organic matrix and light-scattering centers dispersed therein, and wherein the organic matrix has a different refractive index from the light-scattering centers.

2. The composition of claim 1 wherein the light-scattering centers are inorganic particles.

3. The composition of claim 2 wherein the inorganic particles are formed from metal oxides.

4. The composition of claim 2 wherein the inorganic particles are formed from materials selected from the group consisting of titanium oxides, zirconium oxides, variations, and combinations thereof.

5. The composition of claim 1 wherein the light-scattering centers comprise complex internal structures.

6. The composition of claim 5 wherein the complex internal structures comprise cores made of titanium dioxide and one or two concentric shells that are made of SiO2 and Al2O3.

7. The composition of claim 2 wherein the inorganic particles have a particle size in the range from about 200 to about 1000 nm.

8. The composition of claim 2 wherein the inorganic particles have a particle size in the range from about 250 to about 600 nm.

9. The composition of claim 1, wherein the light-scattering centers each comprise a solid core and one or more solid shells, the shells comprising a material different from that of the core.

10. The composition of claim 1 wherein the light-scattering centers include bubbles with a gasseous core.

11. The composition of claim 1 wherein the biological molecules is a nucleic acid.

12. A method for preparing a substrate for immobilizing at least one biological molecule, the method comprising:
(a) preparing a mixture of at least one gel-forming component and inorganic light-scattering centers having a refractive index greater than 1.6;
(b) preparing a coating of the mixture on a solid support; and
(c) curing the coating.

13. A method of enhancing fluorescent yield in biochips with a porous polymeric immobilization layer, the method comprising:
(a) providing a solid support having a top surface with reactive molecules thereon; and
(b) applying a porous polymeric layer on the top surface of the solid support, the polymeric layer comprising:
(iv) one or more biomolecular probes immobilized therein; and
(v) multiple inclusions dispersed therein, the inclusions characterized by a predetermined mean size, a refractive index substantially different from the refractive index of the porous layer, and low absorption of light.

14. The method of claim 13, wherein the inclusions have a predetermined mean size in the range of about 0.1 μm to about 0.8 μm.

15. The method of claim 13, wherein the difference in refractive indexes between the inclusions and the polymeric layer is at least 0.2.

16. The method of claim 13, wherein the inclusions are predominantly in a solid phase.

17. The method of claim 16, wherein the solid phase is an amorphous or single crystal material.

18. A method of preparing a biochip with a hydrogel immobilization layer and enhanced fluorescent yield, the method comprising:
(a) providing a solid support treated to bind to the hydrogel molecules thereon;
(b) providing a hydrogel polymerization composition with solid particles dispersed therein, the solid particles characterized as having:
(i) a refractive index of at least 1.8;
(ii) a predetermined mean size; and
(iii) low absorption of light;
(c) placing said hydrogel polymerization composition on the solid support;
(d) photochemically crosslinking the hydrogel polymerization composition to obtain the hydrogel with the solid particles entrapped therein;
(e) dispensing solutions of biomolecular probes on the hydrogel, and
(f) covalently binding the biomolecular probes to reactive groups of the hydrogel.

19. A method of preparing a hydrogel-based biochip with enhanced fluorescent yield and a hydrogel immobilization layer patterned as an array of spatially separated hydrogel cells, the method comprising:
(a) providing a solid support having a top surface with reactive molecules thereon;
(b) providing a hydrogel polymerization composition;
(c) providing one or more solutions of biomolecular probes chemically modified to allow covalent binding to gel-forming components of said hydrogel polymerization composition, the solutions miscible with the polymerization composition of step (b);
(d) providing a dispersion of solid particles, the dispersion miscible with the polymerization composition of step (b), and the solid particles characterized as having:
(i) a refractive index of at least 1.8;
(ii) a predetermined mean size;
(iii) low absorption of light; and
(e) combining together the solutions of biomolecular probes of step (c) with polymerization composition and dispersion of steps (b) and (d), and stirring the resulting polymerization compositions;
(f) dispensing the compositions of step (e) as droplets at predetermined locations on the support of step (a);
(g) photochemically polymerizing the droplets of step (f) to obtain cells of said hydrogel array with the solid particles entrapped therein.
